(19) United States
(12) Patent Application Publication
(10) Pub. No.: US 2005/0159228 A1
(43) Pub. Date: Jul. 21, 2005

(54) Rotor vibration damper

(76) Inventor: Pavel Otavsky, Nashua, NH (US)

Correspondence Address: Attn: William E. Hilton;Samuels, Gauthier & Stevens, LLP, Suite 3300, 225 Franklin Street, Boston, MA, 02110, US

(21) Appl. No.: 10/218,759

(22) Filed: Aug. 14, 2002

(51) Int. Cl. F16C 3/00

(52) U.S. Cl. 464/180

(57) ABSTRACT

A rotor assembly is disclosed for a reciprocating rotor device comprising a vibration dampening composite that is fixed to a rotor. In various embodiments the vibration dampening composite may include a mass that is fixed with respect to the rotor using a compliant mounting material such as an elastomeric material or an acrylic adhesive.

### BACKGROUND

The invention relates to limited rotation motors such as in galvanometers, and particularly relates to limited rotation torque motors used to drive optical elements such as mirrors for the purpose of guiding light beams in scanners.

Limited rotation torque motors for reciprocating use generally include a rotor and drive circuitry for causing the rotor to oscillate about a central axis. Such systems may also include a position transducer, e.g., a tachometer or a position sensor, and a feedback circuit coupled to the transducer that permits the rotor to be driven by the drive circuitry responsive to an input signal and a feedback signal. Galvanometer motors are typically required to undergo very rapid changes in rotational speed and direction. In an ideal galvanometer scanner the rotor, mirror and position detector are supported on bearings such that the only degree of freedom is rotation and all move as a rigid body. At relatively low rates of changes in direction (i.e., low frequencies), galvanometers move as a rigid body, but at certain frequencies the rotor itself exhibits torsional resonance that superimposes movement on the movement of the rotor as a rigid body. The movement may be sensed by a position detector and may be amplified by the control system leading to instability. The ability to move the galvo rotor as a rigid body a low frequencies only presents a limitation on the performance of the system. If ignored, it may lead to damage or destruction of the galvanometer by exceeding the allowable stresses on the rotor or by overheating the coils of the stator.

One approach to reducing the effect of such torsional resonance is to filter the resonant frequencies of the rotor from the sensed signal, for example by using a notch filter or a low pass filter. Although such signal filtering may reduce the effect of the torsional resonance, the filtering also reduces the energy that may be delivered to the rotor resulting in lower system performance.

There is a need, therefore, for a limited rotation torque motor system that is able to operate at relatively high frequencies without negatively impacting performance by producing torsional resonance.

### SUMMARY OF THE INVENTION

A rotor assembly is disclosed for a reciprocating rotor device comprising a vibration dampening composite that is fixed to a rotor. In various embodiments the vibration dampening composite may include a mass that is fixed with respect to the rotor using a compliant mounting material such as an elastomeric material or an acrylic adhesive.

### BRIEF DESCRIPTION OF THE DRAWINGS

The following description may be further understood with reference to the accompanying drawings in which:

FIG. 1 shows an illustrative end view of a rotor system in accordance with an embodiment of the invention;

FIG. 2 shows an illustrative sectional view of the rotor system of FIG. 1 taken along line 2-2 thereof;

FIG. 3 shows an illustrative enlarged sectional view of a portion of the rotor system shown in FIG. 2;

FIG. 4 shows an illustrative end view of a rotor system in accordance with another embodiment of the invention;

FIG. 5 shows an illustrative sectional view of the rotor system of FIG. 4 taken along line 5-5 thereof;

FIG. 6 shows an illustrative enlarged sectional view of a portion of the rotor system shown in FIG. 5;

FIG. 7 shows an illustrative side view of a rotor system in accordance with a further embodiment of the invention;

FIG. 8 shows an illustrative top view of the rotor system of FIG. 7 taken along line 8-8 thereof;

FIG. 9 shows an illustrative end view of the rotor system of FIG. 9 taken along line 9-9 thereof;

FIG. 10 shows an illustrative sectional side view of possible locations of damping material in a simplified rotor system in accordance with various embodiments of the invention as well as illustrative graphical views of resonant nodes and anti-nodes for the rotor;

FIG. 11 shows an illustrative sectional side view of a galvanometer for scanning combined with a functional block diagram of a system in accordance with an embodiment of the invention; and

FIG. 12 shows an illustrative sectional side view of a galvanometer for scanning in accordance with another embodiment of the invention.

The drawings are shown for illustrative purposes and are not to scale.

### DETAILED DESCRIPTION OF THE ILLUSTRATED EMBODIMENTS

Applicant has discovered that although in general it is desirable to reduce the mass (and therefore inertia) of a rotor in a reciprocating rotor device, it is possible to add a mechanical damper to the rotor that reduces the amplitude of the torsional resonances and improves the performance of the system. The mechanical damper may include a mass that is attached to the rotor by a compliant mounting material that permits the mass to move relative the rotor. The compliant mounting material should exhibit high damping, and may be for example, an elastomeric material such as rubber, or an acrylic adhesive. The coupling of damper mass to rotor must have relatively low stiffness and must have high damping. At low frequencies, the damper mass does not move relative to the rotor but rather follows the rotor movement. At high frequencies (e.g., two or three orders of magnitude higher than the low frequencies), the damper mass does not follow the rotor movement exactly and the coupling material undergoes deformation and absorbs energy. This system reduces the amplitude of the resonance sensed by the position detector and may permit the system to achieve higher overall performance. In particular, such a system may achieve shorter step times (e.g., movement of the galvanometer rotor from one angular position to another), as well as improved velocity control (e.g., constant velocity) during a scan.

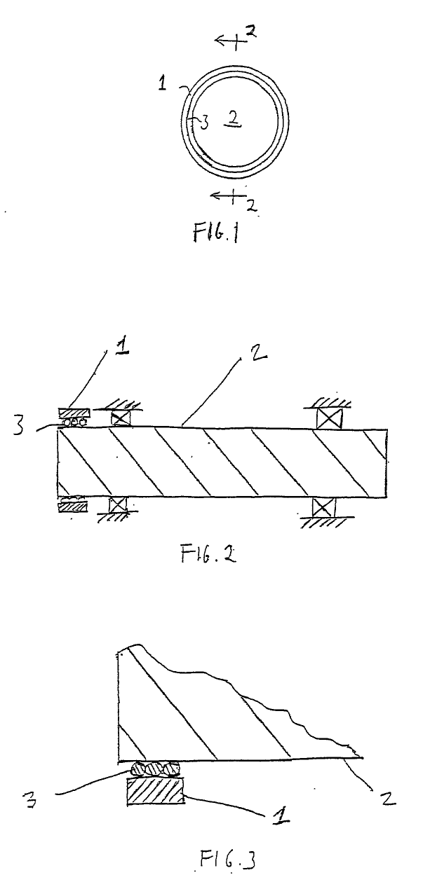

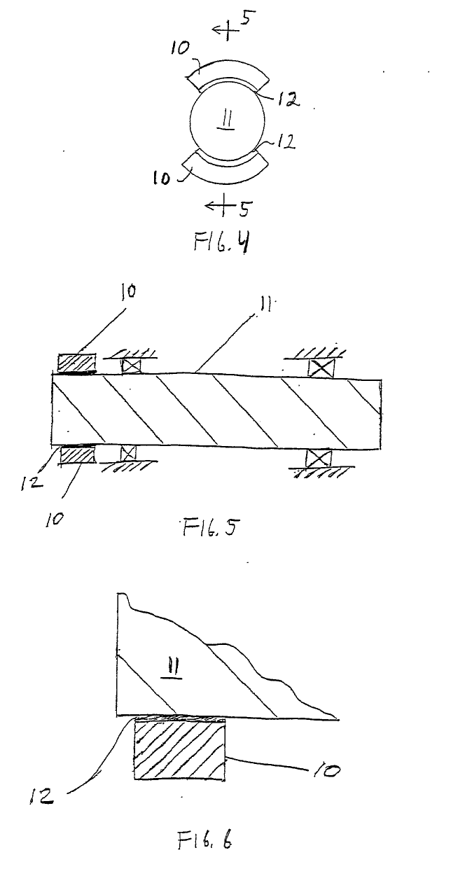

As shown in FIGS. 1-3, a rotor assembly in accordance with an embodiment of the invention includes a dampening mass 1 in the shape of a ring that is attached to a rotor 2 by a compliant mounting material 3 that is also ring shaped. The compliant mounting material 3 may be in the form of a plurality of rings (e.g., O-rings) that are fixed to both the rotor and to the mass 1. At low frequencies, the mass 1 will rotate with the rotor 2, but at high frequencies, the mass 1 will not exactly follow the movement of the rotor 2 resulting in a small amount of deformation of the compliant mounting material 3. This deformation and shift in mass 1 with respect to the rotor reduces the amplitude of the rotor movement at the frequency of the torsional resonance of the rotor 2.

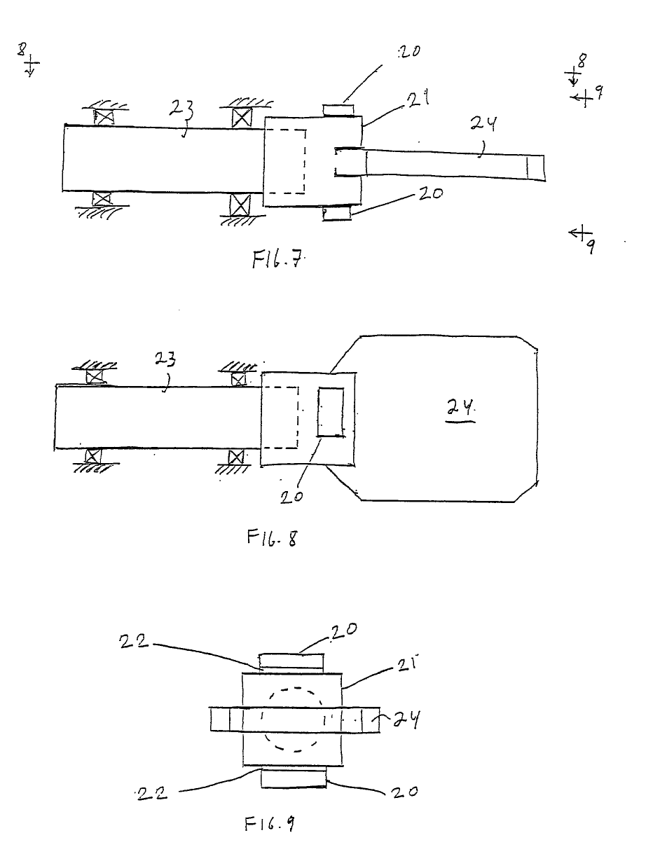

As shown in FIGS. 4-6, a rotor assembly in accordance with a further embodiment of the invention includes a pair of dampening masses 10 that are mounted to a rotor 11 by compliant material 12 such that they radially oppose one another as shown in FIG. 4.

As shown in FIGS. 7-9, a rotor assembly in accordance with a further embodiment of the invention involves mounting a dampening mass 20 onto a mirror mount 21 by means of a compliant mounting material 22. The mirror mount 21 is fixed to a rotor 23 and a mirror 24 is fixed to the mirror mount 21.

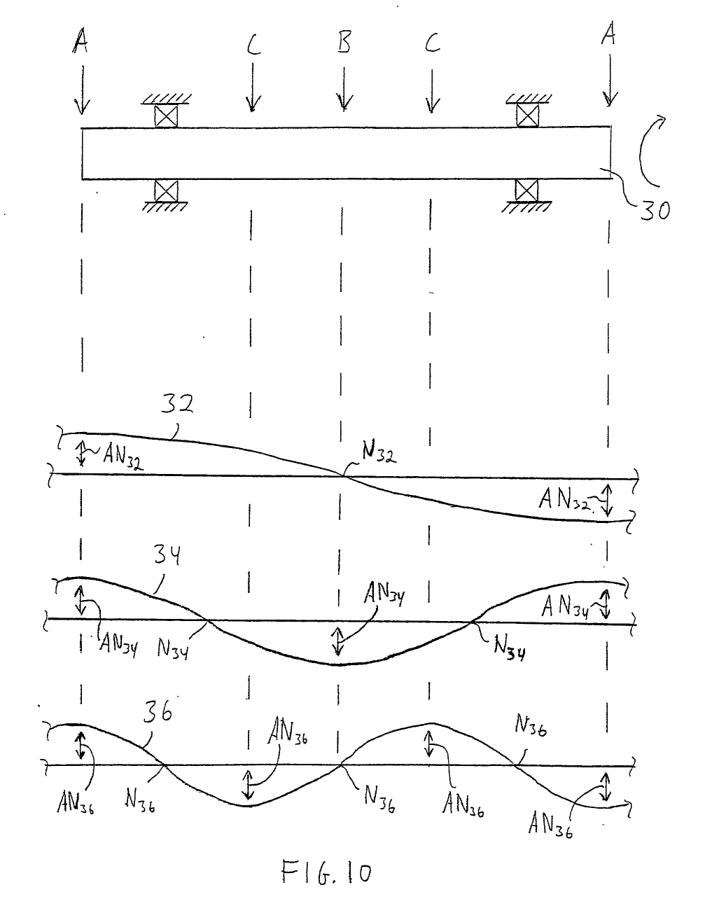

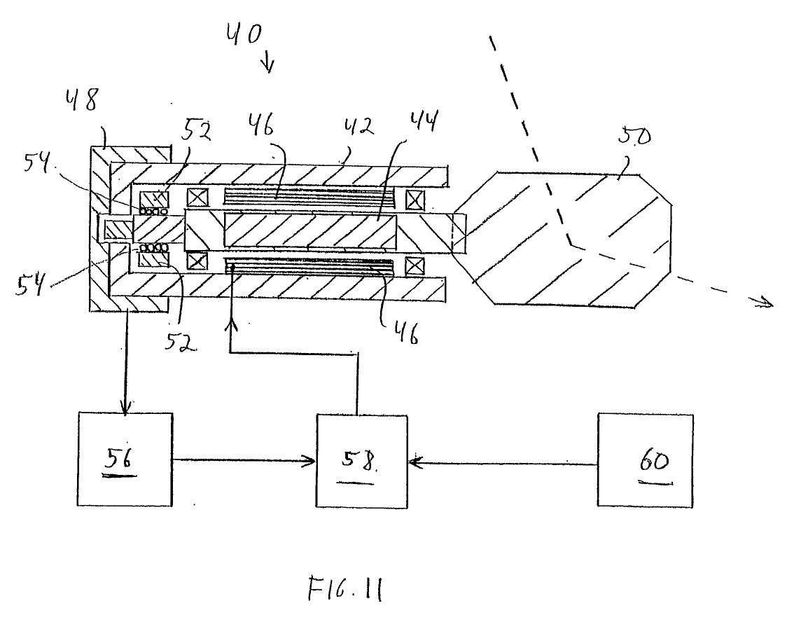

The placement of the dampening mass on the rotor should take into account the mode shapes of the torsional resonances of the rotor. Preferably, the dampening mass should be placed at locations that experience the maximum rotation at resonant frequencies (anti-nodes). The graphs 32, 34 and 36 depict various possible examples of nodes and antinodes that may exist in the rotor 30 during rotation. The nodes in graphs 32, 34 and 36 are indicated by the references N₃₂, N₃₄ and N₃₆ respectively as shown and the antinodes are indicated at AN₃₂, AN₃₄ and AN₃₆ respectively as shown. If, for example, the graph 32 depicts the torsional resonance of the rotor 30, then the dampening mass may be placed at locations A on rotor 30. If the graph 34 depicts the torsional resonance of the rotor 30, then the dampening mass may be placed at locations A and B on rotor 30. If the graph 34 depicts the torsional resonance of the rotor 30, then the dampening mass may be placed at locations A and C on rotor 30. Information regarding the rotor resonance is helpful, therefore, in determining optimal placement of the dampening material. The ends of a rotor that has free-free support in rotation (which is typical for moving magnet galvanometers) are always anti-nodes, one of which is typically where a mirror is mounted. The opposite end is where the position detector may be mounted. This principle applies to all possible rotor configurations and bearing support configurations, whether the bearings are substantially at the ends of the rotor or closer to the middle of the length of the rotor. Further, this applies to rotors that have a variety of different masses and stiffnesses yielding varying torsional resonance nodes other than those shown in FIG. 10. The placement of the permanent magnet may be approximately in the middle of the rotor or at one end of the rotor, between the bearings or outside of the bearings. The type or placement of the driving means (e.g., magnet) does not affect the benefits of the damping system, however, it does affect the mass and stiffness distribution and consequently the resonant mode shapes which is why there is a need for a thorough understanding of the mode shapes.

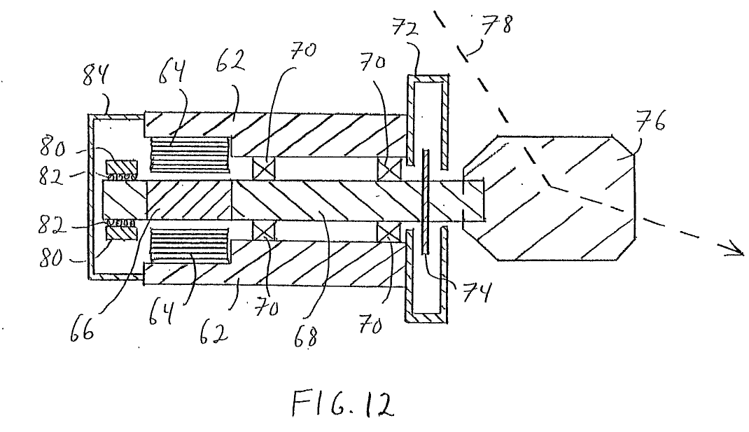

As shown in FIG. 11, a galvanometer system 40 for use in a scanner in accordance with an embodiment of the invention may include a stationary motor housing 42, a rotor with a magnet 44 supported on bearings to permit rotation about its axis, stator coils 46 that are attached to the housing 42, a position detector housing 48 containing a position detector that provides a rotor position signal to the position detection unit, and a mirror 50. The system 40 may also include a dampening mass 52 that is coupled to the rotor shaft by compliant mounting material 54. The system may further include a position detection unit 56, a servo driver unit 58 and a controller 60.

Generally, during use the driver 58 drives current through the stator coils 46 responsive to the controller 60 and the position detection unit 56. At low frequencies the dampening mass 52 rotates with the rotor 44, but at relatively high frequencies the mass 52 does not exactly follow the movement of the rotor causing the compliant mounting material to deform slightly. When the rotor oscillation frequency returns to a lower level, the compliant mounting material returns to its original shape permitting the mass 52 to again follow the rotor movement exactly at low frequencies.

As shown in FIG. 12, an alternative embodiment of a scanner system includes a stationary housing 62, with attached motor coils 64, as well as bearings 70 on which the rotor 68 is supported and able to move about its axis. The rotor 68 includes a driving magnet 66 that is located outside of the space delimited by the bearings 70. The rotor 68 supports a mirror 76 that deflects a signal beam 78. The rotor 68 also supports a damper mass 80 in the form of a ring that is mounted by means of a compliant material 82 to the rotor 68 and is located at the end of the rotor 68 opposite the mirror 76 end and enclosed by a cover 84. The stator housing 62 includes a position detector housing 72 that encloses a position detector 74, which is attached to the rotor 68 in a rigid fashion so that it moves with the rotor 68.

Those skilled in the art will appreciate that numerous modifications and variations may be made to the above disclosed embodiments without departing from the spirit and scope of the invention.

1. A rotor assembly for a reciprocating rotor device comprising a vibration dampening sub-assembly that is fixed to a rotor.

2. A rotor assembly as claimed in clam 1, wherein said vibration dampening sub-assembly includes a mass and a compliant mounting material for attaching the mass to the rotor.

3. A rotor assembly as claimed in claim 1, wherein said compliant mounting material includes an elastomeric material.

4. A rotor assembly as claimed in claim 1, wherein said compliant mounting material includes acrylic adhesive.

5. A galvanometer scanner rotor assembly comprising a mass that is attached to a rotor using a compliant mounting material such that said mass may move with respect to said rotor when said rotor is driven by electromagnetic forces at high frequencies.

6. A galvanometer scanner rotor assembly as claimed in claim 5, wherein said compliant mounting material includes an elastomeric material.

7. A galvanometer scanner rotor assembly as claimed in claim 5, wherein said compliant mounting material includes acrylic adhesive.

8. A galvanometer scanner rotor assembly as claimed in claim 5, wherein said assembly includes a plurality of masses that are attached to a rotor using compliant mounting material such that said plurality of masses may move with respect to said rotor when said rotor is driven at high frequencies.

9. A rotor assembly for a reciprocating rotor device comprising a vibration dampening material that is fixed with respect to a rotor when said rotor is driven at low frequencies, but may move with respect to said rotor when said rotor is driven at high frequencies.

10. A rotor assembly as claimed in claim 9, wherein said rotor assembly includes a compliant mounting material.

11. A rotor assembly as claimed in claim 10, wherein said compliant mounting material includes an elastomeric material.

12. A rotor assembly as claimed in claim 10, wherein said compliant mounting material includes acrylic adhesive.

13. A rotor assembly as claimed in claim 10, wherein said compliant mounting material is attached to said rotor.

14. (canceled)

15. (canceled)
